(19) United States
(12) Patent Application Publication
(10) Pub. No.: US 2022/0019198 A1
(43) Pub. Date: Jan. 20, 2022

(54) COMPONENT ASSEMBLY VIA ON COMPONENT ENCODED INSTRUCTIONS

(71) Applicant: Hewlett-Packard Development Company, L.P., Spring, TX (US)

(72) Inventors: William J. Allen, Corvallis, OR (US); David Murphy, Palo Alto, CA (US); Chin Kee Lim, Singapore (SG)

(73) Assignee: Hewlett-Packard Development Company, L.P., Spring, TX (US)

(21) Appl. No.: 17/298,525

(22) PCT Filed: Apr. 8, 2019
(86) PCT No.: PCT/US2019/026371

§ 371 Date: May 28, 2021

(51) Int. Cl. G05B 19/418

(52) U.S. Cl. CPC G05B 19/41805; G05B 2219/31053

(57) ABSTRACT

In one example in accordance with the present disclosure, a method is described. According to the method, from assembly instructions for a multi-component device, component-specific assembly instructions are generated for a component. The component-specific assembly instructions include a portion of the assembly instructions that relate to the component. Data identifying the component-specific assembly instructions are encoded into a format to be formed onto the component and the encoded data is formed onto the component.

### BACKGROUND

Millions of products are produced and introduced into the economic stream every day. These millions of products are produced at any number of manufacturing facilities that dot the globe. The building of certain types of products may be incredibly complex with large numbers of pieces and many operations to create a product for consumer use.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a flow chart of a method for component assembly via on component encoded instructions, according to an example of the principles described herein.

FIG. 2 is a block diagram of a system for component assembly via on component encoded instructions, according to an example of the principles described herein.

FIGS. 3A and 3B depict pre- and post-assembly components with assembly instructions encoded thereon, according to an example of the principles described herein.

FIG. 4 is a flow chart of a method for component assembly via on component encoded instructions, according to another example of the principles described herein.

FIG. 5 is a block diagram of a system for component assembly via on component encoded instructions, according to another example of the principles described herein.

FIG. 6 depicts a non-transitory machine-readable storage medium for component assembly via on component encoded instructions, according to an example of the principles described herein.

FIG. 7 depicts a non-transitory machine-readable storage medium for component assembly via on component encoded instructions, according to another example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In today's growing society, millions of products are produced every day. Different manufacturing operations are implemented to create and/or assemble these products. Manufacturing processes may facilitate reliable assembly of complex devices made up of a plurality of individual components. In general, manufacturing instructions may exist independent of the specific components, and the assembly process is governed at least in part by the arrangement of the factory line. Such an assembly process may include execution of an ordered list of instructions, finding mating components, performing specified operations, and validating results.

While such manufacturing processes may effectively produce different kinds of products, enhancements to the manufacturing process may increase process efficiency and product yield. For example, in sequential manufacturing operations, downstream processes may be upheld by a delay in an upstream process. Moreover, it may be the case that part of the assembly process is defined by the construction and arrangement of the factory line. That is, assembly lines, and other instances where relative physical positions of manufacturing entities are at least partially dictated by assembly order of operations, are physical examples of a sequence of operations. That is, the layout of the assembly line and manufacturing facility in general, expresses an order of operations. These systems may struggle to accommodate creation of heterogeneous modules, such as customizations based off of a template design.

Moreover, certain operations carried out in a predetermined sequence may result in many of the operations being carried out in one large facility, rather than multiple smaller facilities. This can increase manufacturing overhead.

As will be described, the present system decouples the manufacturing operations from the arrangement of the factory line by embedding the instructions on the components of the device to be assembled. That is, an order of the manufacturing operations is not constrained. In other words, there is no imposed order of manufacturing; there is no proverbial assembly line. According to the present specification, different entities, in some examples in different geographic regions, can coordinate and cooperate to create the devices.

Specifically, the present specification describes a method. According to the method, component-specific assembly instructions are generated for each component in a device that includes multiple components. The component-specific assembly instructions include the portion of the assembly instructions that relate to the component. Data identifying the component-specific assembly instructions are encoded into a format to be formed onto the component and the encoded data is directly formed onto the component.

The present specification also describes a system. The system includes a scanning device to capture encoded data from a component of a device. An extraction device of the system extracts the encoded data and a translator decodes the encoded data to generate component-specific assembly instructions for the component. An assembly device of the system performs an assembly operation based on the component-specific assembly instructions.

The present specification also describes a non-transitory machine-readable storage medium encoded with instructions executable by a processor. The machine-readable storage medium includes instructions to 1) generate assembly instructions for a device that includes multiple components and 2) generate from the assembly instructions, component-specific assembly instructions for a component, wherein the component-specific assembly instructions comprise just a portion of the assembly instructions that relate to the component. The machine-readable storage medium also includes instructions to 1) encode the component-specific assembly instructions onto the component and 2) form the component.

Accordingly, using the present systems and methods, multiple distinct modules (or groupings of components) can be manufactured by any number of entities, each operating according to static instructions. This may be done by supplying a different set of appropriately marked components to the respective entities.

That is, there may not be any sequential list of instructions, or any physically sequential assembly stations. Instead, instructions that relate to just a component are permanently formed on that component. In this system components are selected, potentially at random; mating components are found; and then assembled to the selected component. Components and assembled subsets of components can be moved to different entities, or the entities may move to the components. In this example, multiple agents may cooperate to accomplish an objective indicated by the component-integrated instructions.

The process of assembly, finishing, and validation may be repeated until a module (formed of various components) is assembled. Such a module may be considered a sub-assembly for use in further device manufacturing operations.

As described herein, manufacturing of a module may be performed in a single facility. However, the present systems and methods may distribute assembly over multiple locations and facilities. That is, instructions are carried on the components themselves, such that manufacturing can occur anywhere appropriate components are found, without needing to move data and/or the components. Moreover, because manufacturing instructions are not expressed in relative physical position of assembly entities, moving a component from location A to location B for processing could be realized with a move of 2 meter or a move of 2000 kilometers.

In summary, using such a system enables more effective manufacturing as autonomous manufacturing cells are capable of finding and following embedded instructions, over a family of supported component types and assembly operations. These manufacturing cells can build a plurality of distinct high-level modules without reprogramming. That is, any number of independent manufacturing entities, operating in arbitrary locations, can use the embedded information to guide cooperative assembly of modules, including previously unseen module designs.

Moreover, the present systems and methods facilitate the assembly of sets of components into modules without access to independent manufacturing instructions that may become lost or out of date. For example, the embedded assembly instructions may carry valuable metadata such as recommended grips for robotic manipulators or expected insertion forces.

Such manufacturing that does not rely on entire device-specific instructions may be particularly relevant for mass customization. That is, mass customization is directly supported as components can easily be individually produced incorporating appropriate unique assembly instructions. For example, suppose one device supports connecting three-dimensional (3D) printed bones into skeleton models for education. Initially a small dog skeleton may be offered. However, by producing a set of bones for a different animal, for example a chicken, an autonomous manufacturing mechanism operating according to the present systems and methods may assemble skeletons of any type of animal simply by examining the supplied set of bones and following a common automated assembly operation. However, the devices disclosed herein may address other matters and deficiencies in a number of technical areas.

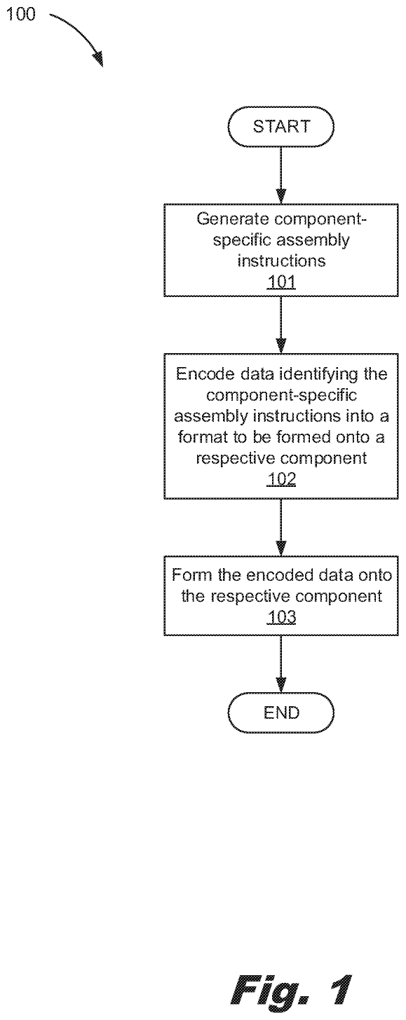

Turning now to the figures, FIG. 1 is a flow chart of a method (100) for component assembly via on component encoded instructions, according to an example of the principles described herein. As described above, a device may be formed of a number of components. In the example method (100) described herein, assembly instructions, rather than being associated with the device in general, are written on a per-component basis. Those instructions, rather than being included separately from the components, are encoded directly on the components or adhered thereto. That is, in some examples, the instructions are permanently formed on the component to which they pertain. Such permanent formation may include printing the instructions onto a three-dimensional (3D) printed component.

According to the method (100), component-specific assembly instructions are generated (block 101) for a component of a device. A device may include multiple components. For example, a model car may have multiple pieces that, when assembled, form the reproduction model of a car. The assembly of the model car may include a number of operations, such as joining an axle component to two wheel components, joining a hood component to a frame component, etc. The assembly instructions for the model car would detail these operations. Component-specific assembly instructions may indicate a per-component manipulation to result in the desired final result. Component-specific assembly instructions may include just a portion of the overall assembly instructions that relate to a particular component. That is, the component-specific assembly instructions may be unique to a particular component, may include assembly instructions just for that component, and in some examples do not include the entire device assembly instructions.

The component-specific assembly instructions may include a variety of pieces of information. For example, component-specific assembly instructions may indicate other components to which the component is to be mated with. For example, a component-specific assembly instruction for a wheel component of the model car may simply indicate what other components are to attach to the wheel component, and where those components are to attach.

In addition to identifying which other components the particular component is to be mated with, the component-specific assembly instructions may indicate how the component is to be joined with those other components. For example, via an adhesive, welded, interference fit, etc.

The component-specific assembly instructions may indicate manufacturing parameters. For example, the assembly instructions may indicate recommended grips for robotic manipulators or expected insertion forces. As another example, the component-specific assembly instructions may include pressures, temperatures or other environmental conditions for joining two components. As yet another example, the assembly instructions may specify the geometry of the connection in a non-visual manner such as identifying a 6 degrees of freedom coordinate specifying a pose of one component relative to another. In summary, the component-specific assembly instructions may indicate settings for the different assembly devices and/or environmental conditions under which components are to be assembled.

As described above, generating (block 101) the component-specific assembly instructions may simply include dividing the assembly instructions based on a component referred to in that instruction. For example, assembly instructions could be searched for the word “wheel” and each operation that identifies a wheel may form the component-specific assembly instructions for a wheel component. In some examples, just those assembly instructions that identify a wheel may form the component-specific assembly instructions.

While particular reference is made to a model car device and a wheel component, the method (100) described herein may be applied to any number of multi-component devices, such as any variety of mechanical devices, electronic devices, and/or electric devices, etc. That is, the method (100) described herein may apply to any multi-component device that is assembled via a set of instructions.

In some examples, the component-specific assembly instructions may indicate an order of assembly of different pieces of the component, or different components of the module. That is, while the present method (100) facilitates non-linear assembly, in some cases it may be desirable to indicate an order of assembly. For example, when assembling a clock, it may be desirable to mount an assembled movement mechanism module to a face component before mounting the hand components onto the movement mechanism module. Accordingly, an order of assembly may be indicated. In this example, a variety of schemes can be employed in the embedded instructions to enforce an order of operations for assembly. As a particular example, a color-coding system may be implemented with different colors having a priority in assembly order over others. For example, assembly instructions pertaining to a label colored black may be executed before assembly instructions pertaining to a label colored brown. Accordingly, a user may select, potentially at random, components with a black color label for assembly. Once all components with a black color label have been assembled, the user may similarly select, potentially at random, components with a brown color label for assembly. The user may continue in this fashion until the entire device is assembled based on a color-specific order of assembly.

In summary, the assembly instructions for a device may be portioned into component-specific assembly instructions, each portion being unique and component specific.

In some examples, the component-specific assembly instructions include partial instructions. Accordingly, when combined with a mating component, additional instructions, such as module-specific assembly instructions are provided. For example, a wheel component of a model car may include certain partial instructions, and an axle component may also include partial instructions. When combined, the resulting instructions may indicate that the axle, with wheels attached, is to be attached to a frame component of the model car. This allows an assembly of components to, when appropriate, take on an independent existence as a module. This new higher-level component may include assembly instructions for further incorporation into subsequent components/modules.

In another example, further assembly instructions may be later embedded into the component, or into its referenced offboard data, after it sits on the shelf as an available asset for some interval. Thus, a scheme causing formation of meta-components forces an order of operation. That is all of the components of a module are assembled and finished before further use.

Data identifying the component-specific assembly instructions is then encoded (block 102) into a format to be formed onto the component. That is, rather than delivering the instructions as a separate object from the component, i.e., as a sheet of paper, the component-specific assembly instructions may be included directly adhered to the component itself. Such encoded data may take many forms. For example, the component-specific assembly instructions may be encoded (block 102) on an RFID chip such that when interrogated by an RF scanner, the assembly instructions are passed to a receiving system to be used for component assembly. Once encoded (block 102), the encoded data is formed (block 103) onto the respective component. In the example of an RFID chip, that may mean adhering the RFID chip to the surface of the component, or embedding the chip inside the component during an additive manufacturing process.

The data may be encoded (block 102) and formed (103) in other ways as well. For example, the assembly instructions may be permanently encoded directly onto the object. In some examples, the encoded data is formed (block 103) on a surface of the object, in other examples, the encoded data is formed inside the object. As an example, an object such as a manufactured product may be encoded with a data payload on the surface of the object. The data may be stored and hidden, or encoded, on the object in any number of ways. For example, the data may be visually imperceptible or may be identified by close inspection and yet be in a format unreadable to humans. That is, the data may not include alphanumeric characters and may instead encode data based on any number of non-alphanumeric fashions including color patterns, raised/unraised surface patterns, and surface texture characteristics.

As a specific example, a manufactured component may include layers of ink that are transparent to visible wavelengths of light and yet absorb infrared wavelengths. Such inks may be used to print a pattern representative of the encoded data that is invisible to the human eye, or otherwise visually imperceptible. In this example, data is encoded (block 102) and formed (block 103) on the product using the transparent ink. An infrared camera/illumination system that can detect the encoded component-specific assembly instructions on the product.

In another example, as mentioned above, the encoded data may be inside the component. For example, a black bar code may be printed on an otherwise white component. This layer may be covered with a thin layer of white plastic or paint. In this example, under low light conditions, the bar code would be difficult or impossible to see under low light levels through the thin layer of white plastic or paint. However, when a bright light was put onto the object, the black bar code just below the surface would become visible.

In one example, the instructions may be encoded (block 102) and formed (103) as slight changes to color, i.e., via color mottling. In this example, an encoder may adjust a number of characteristics of a portion of the component. For example, pixel values may be slightly altered, which alteration value is indicative of a bit of information, which when extracted serves to communicate the data payload, i.e., the component-specific assembly instructions.

In another example, the component includes a pattern of raised surfaces. In these examples, data may be encoded on the raised surfaces. That is, the orientation, shape, and or height of the different surfaces may be detected with different angles, shapes, and/or heights mapping to different bits. Accordingly, in this example, the component-specific assembly instructions may be converted into a pattern of raised surfaces. An encoder may form (block 103) the encoded data in the component by adjusting a number of characteristics of the raised surfaces, such as a height, shape, size, and/or orientation of the raised portions. The height, shape, size, and/or orientation of the raised portions may be indicative of a bit of information, which when extracted serves to communicate the data payload, i.e., the component-specific assembly instructions.

In either of these examples, a user, upon very close inspection, may be able to detect the changes. For example, the mottling included in the image may be subtle, and most pixels within the component may have values within a narrow band of digital counts. In this manner, an encoding device adjusts the values of certain pixels to encode the frequency-domain data payload as a low-visibility watermark within the component. In other examples, a user, even upon close inspection may not detect the encoded data as it has been entirely obscured.

However, even in the event an individual could detect the changes in color or other surface pattern, the data may be encoded in a format unreadable to humans, for example with differences in pixel color or size/shape/orientation of surface elements, such that an individual would not be able to decipher the data. As yet another example, the information may be stored in electromagnetic resonators with distinct frequency responses.

Thus, in summary, while a user may be able to detect a difference in the component in the region where the data is encoded, in some cases the user would not generally be able to decipher the encoded data. That is, the encoding may not rely on alphanumeric characters, but may be encoded any number of other ways including mottling of the color, surface characteristics of a raised texture, etc.

While specific reference is made to particular forms of the encoded data, the encoded data may take many forms which may be formed (block 103) on the component itself. For example, the encoded data may take the form of a pattern of shapes, an alteration of color, pattern and/or characteristics of raised and unraised sections. Even further, in some examples, the data may be alphanumeric codes and visible bar codes.

The data itself may also be of varying types. That is, in some examples, the data that is encoded (block 102) and formed (block 103) on the component may be the component-specific instructions themselves. In other examples, the encoded data may be a pointer to a location where the component-specific assembly instructions are found. As a specific example, the encoded information may include a uniform resource locator (URL), to a location on a remote server where the target values are located. In this example, extracting assembly instructions includes extracting the information from a location identified by a pointer in the encoded data.

In the example where the encoded information includes a pointer to a location, it may be the case that the component-specific assembly instructions at that location are updated during the assembly process. That is, when the embedded information points to off-part instructions, those instructions may be changed dynamically.

In another example where the encoded information includes a pointer to a location, it may be the case that the component-specific assembly instructions at that location are generated during the assembly process. That is, the component-specific assembly instructions are generated on-demand or just in time relative to when the respective component is to be assembled. That is, the instructions could be changed, or determined for the first time, after at least one assembly operation has been initiated.

For example, the component-specific assembly instructions located at a URL may be updated once it is confirmed that a particular operation has been done. This allows manipulation of the component-specific assembly instructions “in-flight” as a control mechanism for optimizing assembly steps and locations, changing product options after making the product available, and optimizing supply chain operations.

It should be noted, that in the present specification reference to encoded data on the component may be interpreted as including a reference to information stored elsewhere. In some examples, the pointer may be to locally managed micro-service. That is the component-specific assembly instructions may be disposed on a site where assembly is to occur. In other examples, the assembly instructions may be stored and managed remotely, for example on a component manager-based server. That is, the manufacturer of the device/component that is assembled may retain the assembly instructions offsite from a third-party assembly site. Such an arrangement provides an ability to control data for security and reliability.

Thus, the method (100) of the present specification allows for inclusion of the assembly instructions on the component to which it pertains. Moreover, the assembly instructions, by being component-specific and not relating to other components of the module and/or device can be asynchronously processed. That is, part A does not need to be assembled prior to part B such that both can be placed in a module C in assembly line fashion. Rather, part A may be formed where most convenient and Part B may be formed where most convenient, and perhaps simultaneously, and both can then be joined into module C. Such an arrangement reduces the constraints imposed by an assembly-line type operation as facilities and operations may be more particularly tailored and customized for a particular assembly process. That is, such component-specific assembly instructions facilitate the random assembly of components without having to follow any predefined sequence of operations to form the device.

It should also be noted that an assembled component may be a component of a higher-level component. That is, it may be the case that a module, which includes multiple assembled components, may be a new component available for incorporation into a higher-level module. That is, the present method (100) may be hierarchically used, in an iterative fashion, to assemble components into a module, and to combine modules (which may themselves be considered components), into higher level structures.

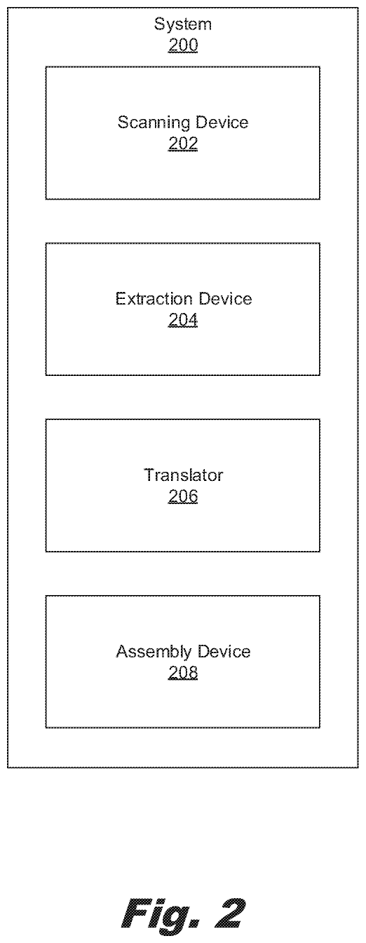

FIG. 2 is a block diagram of a system (200) for component assembly via on component encoded instructions, according to an example of the principles described herein. In some examples, the system (200) may be formed in a single electronic device. In other examples, the system (200) may be distributed, meaning that different components are on different devices. For example, one device may include any combination of a scanning device (202), extraction device (204), and assembly device (208) while a translator (206) may be on a separate device. The system (200) may form part of a manufacturing or assembly apparatus for a device.

The system (200) includes a scanning device (202) to capture encoded data from a component of a device. In some examples, the encoded data is formed on a surface of the component. The data may be stored and hidden, or encoded, on the component in any number of ways. For example, the data may be visually imperceptible or may be identified by close inspection and yet be in a format unreadable to humans. That is, the data may not include alphanumeric characters and may instead encode data based on any number of non-alphanumeric fashions. In another example, as mentioned above, the encoded data may be inside the object.

In these examples, the encoded data is optical. In other examples, the data may be encoded in another form. For example, the encoded data may be formed on a radio frequency identification (RFID) tag embedded inside the object, or adhered to the object. In this example, the encoded data is in the form of radio-frequency energy.

The scanning device (202) may be of a variety of types based in part on the form of the encoded data. For example, the scanning device (202) may be a camera disposed on a smartphone, which camera takes a picture of the component. The scanning device (202) may be of other types such as an optical scanner, a laser scanner, and a radio-frequency transceiver among others.

As a specific example and as described above, in some examples the encoded data may be visually imperceptible to individuals. As a specific example, a component may include layers of ink that are transparent to visible wavelengths of light and yet absorb infrared wavelengths. In this example, the scanning device (202) may be an infrared camera/illumination system that can detect the infrared pattern on the printed image.

In another example, the object includes a pattern of raised surfaces. In this example, the scanning device (202) may include an optical light-based scanner that can detect, via light beams or other detectors, the angles, shapes, and/or heights such that the encoded data mapped to these characteristics can be extracted.

The system (200) also includes an extraction device (204) to extract the encoded data. That is, the scanning device (202) captures an image of the encoded data, or a region of the component where the encoded data is found, and the extraction device (204) extracts from that image, or from that region of the component, the encoded data.

As described above, the encoded data may be in any variety of forms including, color mottling, raised texture patterns, adhered RFID or other tags. The extraction device (204) may be able to detect the encoded data and extract it. While specific reference is made to particular forms of the encoded data, the encoded data may take many forms.

The system (200) also includes a translator (206) to decode the encoded data to generate component-specific assembly instructions for the component. For example, the translator (206) may access a mapping between an output of the extraction device (204) and bits of data such that when encoded data is detected, the translator (206) may discern an associated bit, or set of bits, to decode the encoded component-specific assembly instructions. By repeating this action, a string of data bits can be re-created from a pattern in the color mottling, texture patterns, etc. Accordingly, the translator (206) is tailored to the specific form of the encoded data. For example, if the data is encoded as a color mottling, the extraction device (204) extracts the color differences and the translator (206) identifies the pixel values at each location and references a database to decipher the data based on the associated pixel values.

In some examples, the information is extracted from the image itself. That is, the data encoded in the component may be the actual component-specific assembly instructions. In other examples, the extraction may be from a different location. That is, the encoded information may include a pointer, such as a uniform resource locator (URL), to a location on a remote server where the component-specific assembly instructions are located. That is, the data in its encoded form, is decoded such that the component-specific assembly instructions can be processed. As described above, this may include decoding a series of bits from the encoded data itself, which bits indicate the component-specific assembly instructions. In another example, this may include directing the system (200) browser to a location identified by a pointer which is included in the encoded data.

The system (200) also includes an assembly device (208) that performs an assembly operation based on the component-specific assembly instructions. This may include any number of operations. For example, as described above, the component-specific assembly instructions may indicate what other components are to be joined with the component of interest. Accordingly, the assembly device (208) may collect the other components.

Additionally, the assembly instructions may indicate how the various components are to be joined, i.e., via adhesive, welding, using a particular insertion force etc. and potentially may indicate the environmental conditions under which the components are to be assembled as well as assembly parameters. Accordingly, the assembly device (208) may perform these operations at the specified conditions and parameters. While particular reference is made to specific assembly devices (208) and operations, the system (200) as described herein may include any variety of type of assembly device (208) used to assemble a component/module of a device.

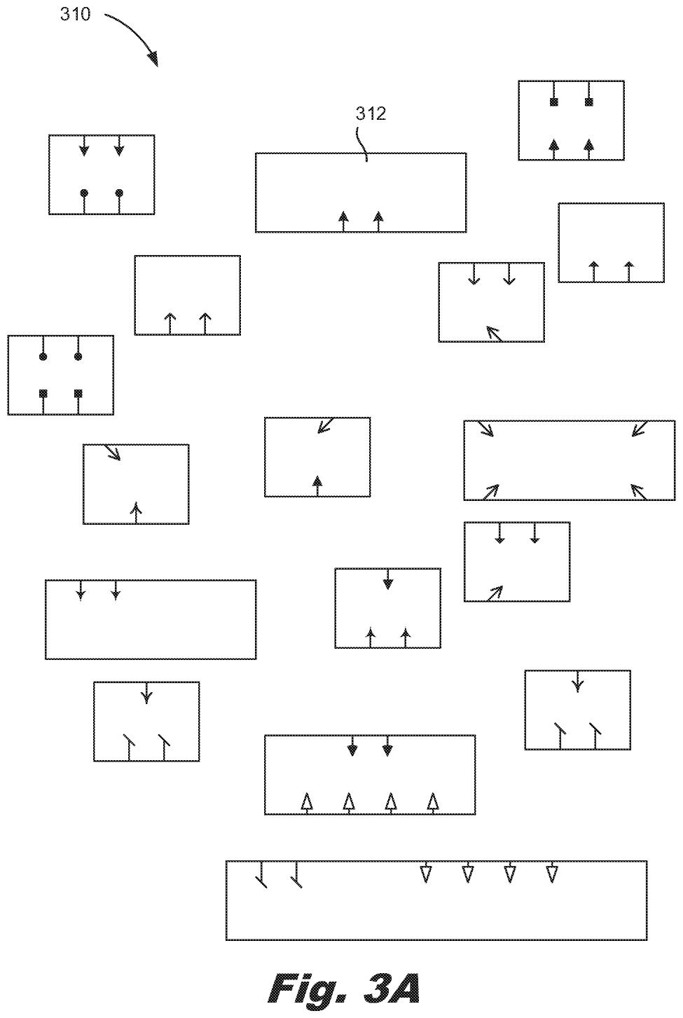

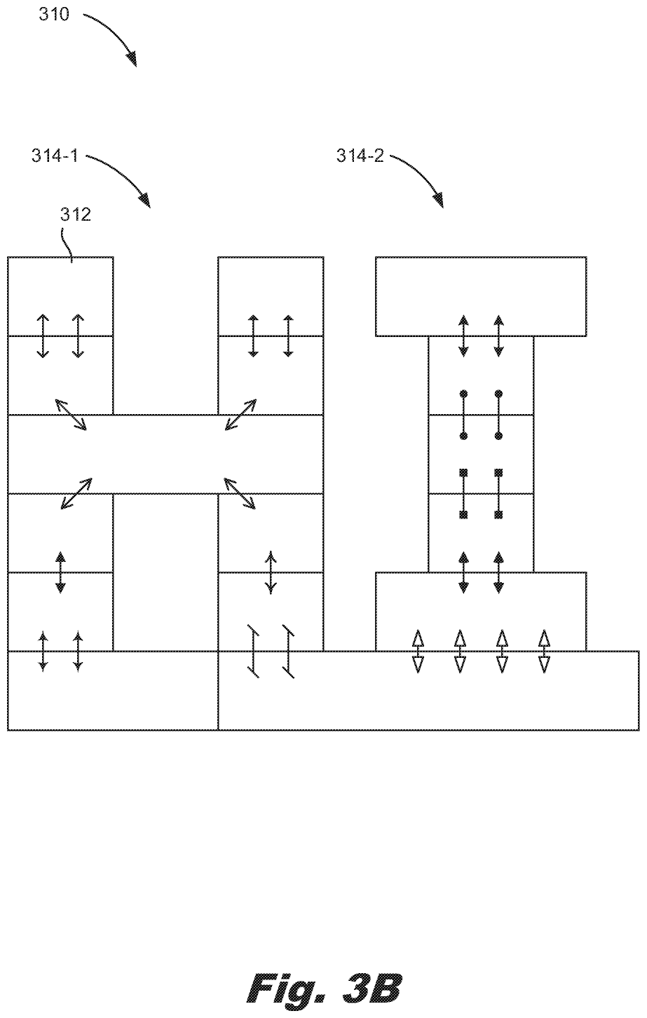

FIGS. 3A and 3B depict pre and post-assembly devices (310) with assembly instructions encoded thereon, according to an example of the principles described herein. As described above, a device (310) may be made up of various components (312) that are to be assembled together to form the device (310). In the example depicted in FIGS. 3A and 3B, the components (312) are modular blocks that are joined together to form a sculpture device (310). While particular reference is made a particular device (310), it should be noted that the systems and methods described herein may assemble more complex devices as well. For simplicity in FIGS. 3A and 3B, just one component (312) is indicated with a reference number.

As described above, in some examples, assembly instructions can be added directly to the components (312). FIG. 3A depicts one particular encoding scheme wherein the assembly instructions are encoded onto one surface of each component (312) as an optically readable mark. In this example, the marks are designed such that there is one possible way to connect any component (312) with another component (312) such that the marks form contiguous symmetric patterns spanning the seam where the components (312) are joined. That is, in this example the encoded assembly instructions include contiguous patterns over components (312) to be joined. However, other arrangements may be available as well, such as unique identifiers on each component (312) identifying the other components (312) that are to join with each other.

FIG. 3B depicts the components (312) in assembled form. That is, different components (312) are paired based on matching patterns to form the sculpture device (310) of the letters “HI.” During assembly, the assembly device (FIG. 2, 208) may carry out a sequence of operations such as, for each non-joined component (312), 1) identifying a pattern disposed thereon, 2) identifying a component (312) with a matching pattern, and 3) combining the components with matching patterns. As described above, because the encoded data was carefully generated, there is just one solution for a complex device (310). Note that in some examples, different devices (310) may be formed form a pool of components (312). For example, if the desired sculpture device (310) is of the letters “AH,” merely supplying a different set of components (312) blocks may be provided to the automated assembly device (FIG. 2, 208) running the same assembly operations described above. In some examples, the components (312) themselves may be physically constrained in how they can fit together. Accordingly, the encoding scheme of the component-specific assembly instructions may rely on the physical constraints of the constituent components (312).

As described above, a device (310) may have multiple modules (314). For example, in FIG. 3B, the sculpture letter “H” may be one module (314-1) and the sculpture letter “I” may be a second module (314-2). In this example, multiple components (312) when joined form a module (314) of the device (312). Accordingly, in this example, similar to the joining of components (312) to form a module (314), the different modules (314) may be joined to form the device (312). In some examples, different modules (314) may be assembled at independent locations; sometimes within the same facility and sometimes in remote locations. Thus, the systems and methods described herein provide for increased flexibility in manufacturing to suit any number of different situations. For example, a producer is not constrained to produce all modules (314) for a device (312) in a given location, but can form the different modules (314) in different locations as it may be more convenient to form a first module (314-1) in a first location and to form a second module (314-2) in a different location based on any number of criteria.

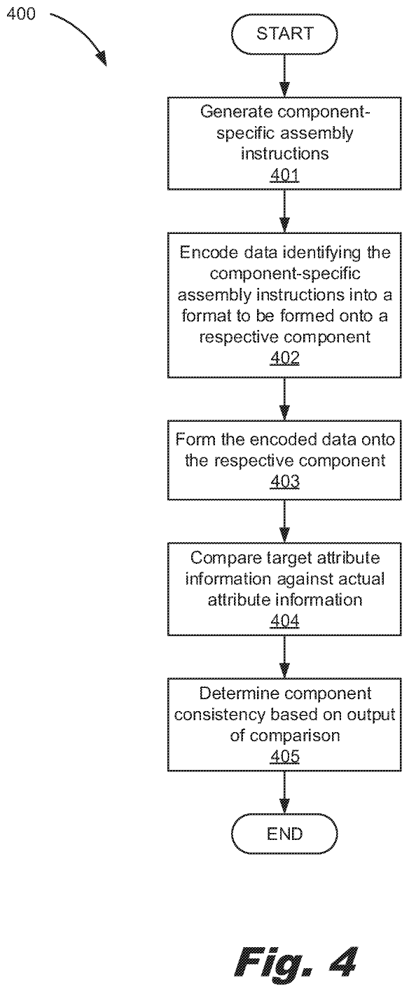

FIG. 4 is a flow chart of a method (400) for component (FIG. 3A, 312) assembly via on component encoded instructions, according to another example of the principles described herein. According to the method (400) component-specific assembly instructions are generated (block 401) and data identifying those component-specific assembly instructions are encoded (block 402) and formed (block 403) onto the respective component (FIG. 3A, 312). In some examples, these operations may be carried out as described above in connection with FIG. 2.

In some examples, the system and method (400) may provide quality assurance and product control mechanisms. That is, the assembly instructions may indicate target attribute information for the component (FIG. 3A, 312), which target attribute information may be compared against actual attribute information to determine component (FIG. 3A, 312) consistency. That is, the embedded component-specific assembly instructions may carry information regarding how to validate a component (FIG. 3A, 312). For example, the expected, or target, CIELAB color coordinates of the surface as measured under some set of conditions may be embedded on a surface of the component (FIG. 3A, 312). A system (FIG. 2, 200) extracts this target attribute information and also acquires actual attribute information by measuring the component (FIG. 3A, 312) itself. That is, data describing target values for a surface attribute are hidden within the component (FIG. 3A, 312) itself and when scanned by a scanning device (FIG. 2, 202) can be used to determine a variation between actual values and the target value for the surface attribute.

The system (FIG. 2, 200) then compares (block 404) the target attribute information against the actual attribute information measured from the component (FIG. 3A, 312). Based on the results of the comparison, component (FIG. 3A, 312) consistency may be determined (block 405). That is, it may be determined if the actual measured surface attribute of the component (FIG. 3A, 312) is within any number of predefined ranges of a desired value, greater than a threshold value, or less than a threshold value. If the actual value is not within specified values, then it may be determined that the component (FIG. 3A, 312) is non-conforming with acceptability conditions, or out of bounds. That is, the results of the comparison will identify whether the actual value is outside of acceptability conditions for the target value.

In one example, the target value may be a lower-limiting threshold where any actual value less than this lower-limiting threshold is deemed inadequate. In another example, the target value may be an upper-limiting threshold where any actual value greater than this upper-limiting threshold is deemed inadequate. In yet another example, the target value may be multiple values that define a threshold range where any actual value outside of the threshold range is deemed inadequate. In yet another example, multiple ranges may be used. For example, an actual value may be acceptable when found between either a first range or a second range. Accordingly, comparison (block 404) of the actual value of the surface attribute with any of these types of target values determines whether the object is outside of predetermined acceptability conditions, that is whether it is unacceptable and whether remedial action should be taken.

Thus, the present method (400) provides for a comparison of surface attributes of the component (FIG. 3A, 312) with target values that are included on the component (FIG. 3A, 312) itself. Thus, rather than consulting an unavailable, or difficult to obtain standard, the standard against which actual values are compared against are included in the component (FIG. 3A, 312) itself. Moreover, such an authentication system does not rely on visual inspection, which is prone to user error and may not be reliable nor accurate. Thus, the method (400) provides machine readable data-bearing components (FIG. 3A, 312) that are not objectional to the eye, do not disfigure a surface, are hidden, and that allow the component (FIG. 3A, 312) to retain its aesthetic qualities.

While one particular method of validation is described as it relates to comparison of target values with actual attribute values, other forms of validation may be implemented. For example, a torque of a bolt could be measured and compared (block 404) with target bolt torque specifications encoded on the component (FIG. 3A, 312) itself. In another example, geometric attributes describing the connection of two joined components (FIG. 3A, 312) could be embedded on the component (FIG. 3A, 312), thus enabling validation of a manufacturing operation which glues two parts together.

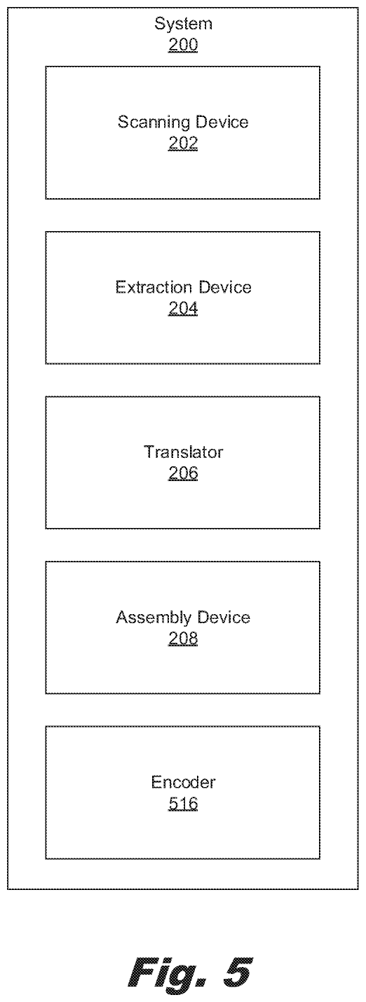

FIG. 5 is a block diagram of a system (200) for component (FIG. 3A, 312) assembly via on component encoded instructions, according to an example of the principles described herein. As described above, the system (200) includes a scanning device (202), extraction device (204), translator (206), and assembly device (208). In the example depicted in FIG. 5, the system (200) also includes an encoder (516) to update the encoded data on the component (FIG. 3A, 312). For example, at any point in the assembly process, the embedded data may be modified. For example, after a particular assembly operation, information embedded within the component (FIG. 3A, 312) may be modified to indicate appropriate remaining operations and/or assembly pairings. Depending on the type of encoded data, the encoder (516) may operate based on various mechanisms. For example, the encoder (516) may change something physical on the component (FIG. 3A, 312). For example, the encoder (516) may add additional color mottling, or may alter an RFID tag to reflect the updated information. In yet another example, the encoder (516) may change data referenced by information on a component (FIG. 3A, 312). For example, the encoder (516) may provide an updated URL directing the system (200) to a new pointer where updated component-specific assembly instructions are included. That is, as described above, component-specific assembly instructions may be changed, or created, after assembly begins. Put another way, the component-specific assembly instructions at a pointed-to location may be adjusted after execution of at least one operation in the component-specific assembly instructions.

For example, the component-specific assembly instructions located at a URL may be updated following a preliminary step, or a number of preliminary steps. This allows manipulation of the component-specific assembly instructions in real-time and specific to a particular assembly operation. Thus, increased customization is provided, and up-to-date assembly instructions can be provided to a user as they are assembling the component.

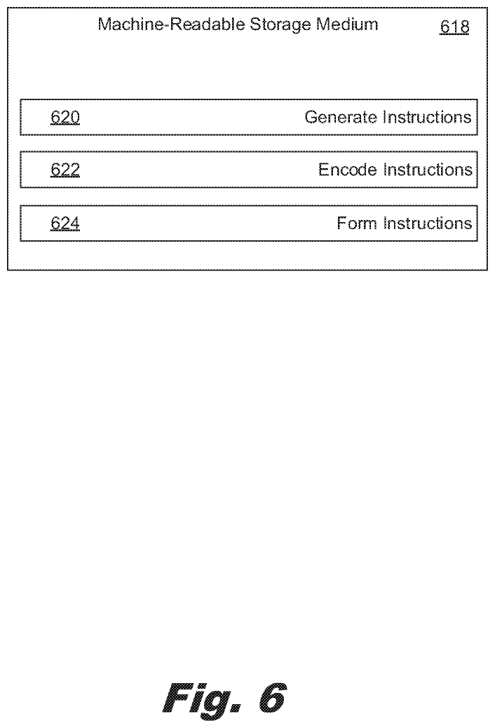

FIG. 6 depicts a non-transitory machine-readable storage medium (618) for component (FIG. 3A, 312) assembly via on component encoded instructions, according to an example of the principles described herein. To achieve its desired functionality, a computing system includes various hardware components. Specifically, a computing system includes a processor and a machine-readable storage medium (618). The machine-readable storage medium (618) is communicatively coupled to the processor. The machine-readable storage medium (618) includes a number of instructions (620, 622, 624) for performing a designated function. The machine-readable storage medium (618) causes the processor to execute the designated function of the instructions (620, 622, 624).

Referring to FIG. 6, generate instructions (620), when executed by the processor, cause the processor to 1) generate assembly instructions for a device (FIG. 3A, 310) that includes multiple components (FIG. 3A, 312) and 2) generate from the assembly instructions, component-specific assembly instructions for a component (FIG. 3A, 312) of the device (FIG. 3A, 310). As described above, the component-specific assembly instructions include just a portion of the assembly instructions that relate to a corresponding component (FIG. 3A, 312). Encode instructions (622), when executed by the processor, may cause the processor to, encode the component-specific assembly instructions onto the component (FIG. 3A, 312). Form instructions (624), when executed by the processor, may cause the processor to form the component (FIG. 3A, 312).

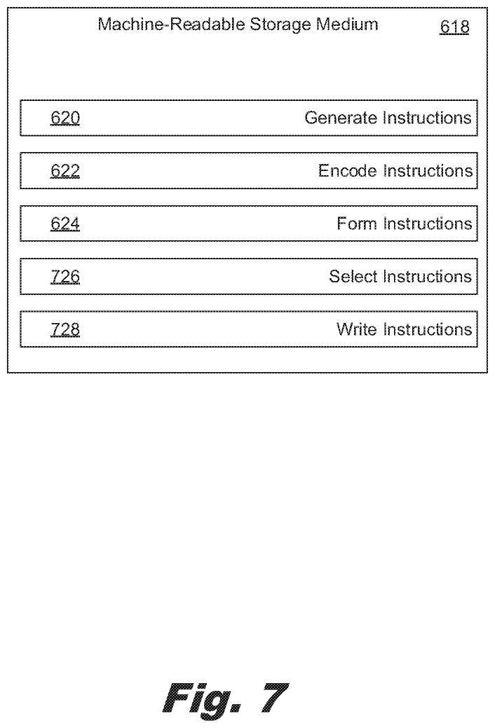

FIG. 7 depicts a non-transitory machine-readable storage medium (618) for component (FIG. 3A, 312) assembly via on component encoded instructions, according to another example of the principles described herein. In addition to the instructions (620, 622, 624), described above, the non-transitory machine-readable storage medium (618) depicted in FIG. 7 includes additional instructions. Select instructions (726), when executed by the processor, cause the processor to select from a pool of components (FIG. 3A, 312), a subset of components (FIG. 3A, 312) to form the device (FIG. 3A, 310). Write instructions (728), when executed by the processor, cause the processor to write assembly instructions to make the device (FIG. 3A, 310) using the subset of components (FIG. 3A, 312). In one example, different combinations of components (FIG. 3A, 312) from the pool of components (FIG. 3A, 312) form different devices (FIG. 3A, 310).

What is claimed is:

1. A method comprising:
generating, from assembly instructions for a device comprising multiple components, component-specific assembly instructions for a component, wherein the component-specific assembly instructions comprise a portion of the assembly instructions that relate to the component;
encoding data identifying the component-specific assembly instructions into a format to be formed onto the component; and
forming encoded data onto the component.

2. The method of claim 1, wherein encoding data identifying the component-specific assembly instructions onto the component comprises at least one of:
encoding the component-specific assembly instructions onto the component; and
encoding onto the component, a pointer to a location where the component-specific assembly instructions are found.

3. The method of claim 2, further comprising adjusting the component-specific assembly instructions at a pointed-to location after execution of at least one operation in the component-specific assembly instructions.

4. The method of claim 1, wherein multiple joined components form a module of the device, a device comprising multiple modules.

5. The method of claim 4, wherein at least one module is assembled at a remote location from at least one other module.

6. The method of claim 4, wherein the component-specific assembly instructions comprise partial instructions such that when combined with another component in a module, module-specific assembly instructions are provided.

7. The method of claim 1, wherein the assembly instructions indicate at least one of:
other components to which the component is to be mated with;
how the component is to be joined to the other components; and
a manufacturing parameter;
and
an order of assembly of components of the module.

8. The method of claim 1, wherein:
the assembly instructions indicate target attribute information for the component; and
the method further comprises:
comparing the target attribute information against actual attribute information measured from the component; and
determining component consistency based on an output of the comparison.

9. A system, comprising:
a scanning device to capture encoded data from a component of a device;
an extraction device to extract the encoded data;
a translator to decode the encoded data to generate component-specific assembly instructions for the component; and
an assembly device to perform an assembly operation based on the component-specific assembly instructions.

10. The system of claim 9, wherein the encoded data is visually-imperceptible.

11. The system of claim 9, wherein the encoded data is in a non-human readable format.

12. A non-transitory machine-readable storage medium encoded with instructions executable by a processor, the machine-readable storage medium comprising instructions to:
generate assembly instructions for a device comprising multiple components;
generate from the assembly instructions, component-specific assembly instructions for a component of the device, wherein the component-specific assembly instructions comprise just a portion of the assembly instructions that relate to the component;
encode the component-specific assembly instructions onto the component; and
form the component.

13. The machine-readable storage medium of claim 12, wherein the machine-readable storage medium further comprises instructions to:
select from a pool of components, a subset of components to form the device; and
write assembly instructions to make the device using the subset of components.

14. The machine-readable storage medium of claim 13, wherein:
different combinations of components from the pool of components form different devices; and
the component-specific assembly instructions facilitate random assembly of components of the device.

15. The non-transitory machine-readable storage medium of claim 12, wherein the encoded assembly instructions comprise at least one of:
a contiguous pattern over components to be joined;
a color coding to impose an order on am assembly of the components; and
a unique identifier of a separate component to be joined to the component.
